(19) United States
(12) Patent Application Publication
(10) Pub. No.: US 2010/0047632 A1
(43) Pub. Date: Feb. 25, 2010

(54) TEST BENCH AND TESTING METHOD FOR A FUEL CELL STACK

(75) Inventors: Jeremy Lawrence, Dresden (DE); Andreas Reinert, Dresden (DE); Bjorn Erik Mai, Dresden (DE); Daniela Sehm, Dresden (DE)

Correspondence Address: FITCH EVEN TABIN & FLANNERY, 120 SOUTH LASALLE STREET, SUITE 1600, CHICAGO, IL, 60603-3406, US

(73) Assignee: STAXER GMBH, Dresden (DE)

(21) Appl. No.: 12/521,975

(22) PCT Filed: Feb. 6, 2008
(86) PCT No.: PCT/DE08/00219

§ 371 Date: Jul. 1, 2009

(30) Foreign Application Priority Data
Feb. 20, 2007 (DE) 10 2007 008 268.3

(51) Int. Cl. H01M 8/00; H01M 10/48; H01M 2/00

(52) U.S. Cl. 429/13; 429/22; 429/34

(57) ABSTRACT

The invention relates to a test stand for a fuel cell stack comprising an insulating device for thermally insulating the fuel cell stack, a media supply device for supplying a gaseous fuel and an oxidising agent to the fuel cell stack and an electronic control device for controlling and/or regulating as well as for monitoring a test method. The invention further relates to a test method for a fuel cell stack.

The invention relates to a test stand for a fuel cell stack. The invention further relates to a test method for a fuel cell stack.

Fuel cells serve to convert chemical energy into electric energy. In this connection a fuel cell supplies a voltage which is, in particular, determined by the electrochemical potentials involved. For multiplying said voltage a plurality of fuel cells are electrically connected in series, particularly a stack arrangement being preferred for this purpose. High standards are to be applied to such a stack arrangement. In particular the individual gas chambers, i.e. the fuel chambers and the oxidising agent chambers have to be separated from each other in a gas tight manner. Furthermore fuel cell stacks, particularly SOFC systems (SOFC=“Solid Oxide Fuel Cell”), need to have a satisfying thermal, mechanical and thermo-chemical load capacity since such systems have to operate stably at operating temperatures above 600° C. During the production of a fuel cell stack and thereafter it is therefore necessary to carefully test the serviceability of the fuel cell stack, namely in particular with respect to the already mentioned leakproofness and stability requirements, but also with respect to different electric load conditions. Aside from this testing of individual fuel cell stacks with respect to their operability results relating to different modes of operation of fuel cell stacks should be obtainable, either as “by-products” of the testing of individual fuel cell stacks or by experimental arrangements especially provided for this purpose.

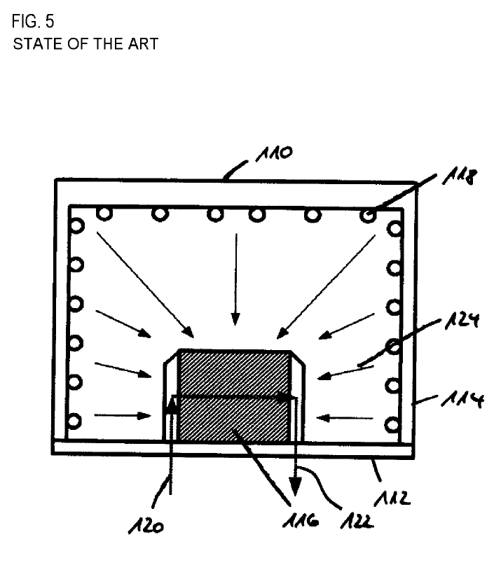

In connection with all these testing and development objectives the thermal balance of the fuel cell stack plays a decisive role. For this reason fuel cell stacks have so far been tested in ovens suitable for providing a thermal environment which is as defined as possible for the fuel cell stack. Such an oven including a fuel cell stack disposed therein is shown in FIG. 5 in the form of a cross sectional view. The oven 110 comprises a base plate 112 and walls 114 arranged thereon. The fuel cell stack 116 is disposed on the base plate 112 while the walls 114 carry heating elements 118. The media supply to the fuel cell stack 116 is effected through the base plate 112, the air supply path 120 and the air discharge path 122 being shown in FIG. 5. A fuel duct may be formed in a comparable manner. Heat radiation 124 is applied to the fuel cell stack 116 by the heating elements 118, and it is tempered in this manner. In this way the fuel cell stack 116 is to be provided with a temperature profile which substantially corresponds to the one in the subsequent use.

In connection with the adjustment of such a temperature profile the state of the art described above has shown to be problematic. In particular a system-oriented temperature profile, i.e. a temperature profile corresponding to the one during the actual use of the fuel cell stack, can hardly be generated over the entire fuel cell stack. The fuel cells facing the base plate 112 and the fuel cells disposed on the opposite end of the fuel cell stack frequently have a significantly lower temperature than fuel cells in the centre of the fuel cell stack 116. This is the result of the interaction with the base plate 112 as well as by heat radiation losses. Further disadvantages are to be observed in connection with the media supply. It is thermally coupled to the oven so that an accurate control of the temperatures of the media is only conditionally possible.

The invention is based on the object to at least partly overcome the problems and disadvantages cited above in which connection particularly a test stand and a test method for a fuel cell stack are to be provided which represent the realistic system conditions to which the fuel cell stack will be exposed during its actual use as well as possible and which prevent local overheating.

Said object is solved by the features of the independent claims.

Advantageous embodiments of the invention are indicated in the dependent claims.

The invention comprises a test stand for a fuel cell stack including an insulating device for the thermal insulation of the fuel cell stack, a media supply device for supplying a gaseous fuel and an oxidising agent to the fuel cell stack and an electronic control device for controlling and/or regulating as well as for monitoring a test method. By accommodating the fuel cell stack in an insulating device the thermal balance of the fuel cell stack can be decoupled from undesirable influences of the environment to a large extent. According to the state of the art a thermal coupling of the fuel cell stack to its environment, namely to the oven in which the test took place, was desired. Now the fuel cell stack is arranged and operated during the test so that the thermal balance is governed by the operation of the fuel cell stack.

Preferably a device for simulating an electric load is provided which absorbs the electric energy generated by the fuel cell stack. In this way the test method can be configured so as to be close to reality. In particular a simulation of the electric load is carried out by the electronic control device which also serves to control and/or regulate as well as to monitor the test methods, wherein particularly software programs and data collection devices are used.

The invention is advantageously further developed in that the insulating device comprises a plurality of insulating plates, at least one insulating plate being at least partially integrated in the media supply device. It may, for example, be contemplated that the fuel cell stack is disposed on a base plate formed as an insulating plate through which the gaseous fuel, i.e., in particular, the hydrogen, is supplied. The air providing the oxidising agent, namely the oxygen, may then advantageously be supplied through a laterally disposed insulating plate. In a fuel cell stack having laterally opened cathode spaces the air may thus simply laterally flow into the fuel cell stack in this way to then flow out again on the other side of the fuel cell stack and to leave the test stand through another laterally disposed insulating plate from there.

Conveniently it is contemplated that the insulating device comprises six insulating plates capable of accommodating the fuel cell stack in a cuboid shape, four insulating plates abutting to the fuel cell stack and two insulating plates being spaced apart from to the fuel cell stack. Owing to the distance between the insulating plates and the fuel cell stack the air supplied through it may be distributed over the entire lateral surface of the fuel cell stack before it enters the cathode sections of the fuel cells.

This is supported by the fact that a plate inducing a distribution of the medium to be supplied to the fuel cell stack is provided between an insulating plate spaced apart from the fuel cell stack and the volume provided for the fuel cell stack. The plate may serve as a baffle plate and at the same time as a distributor plate. With different embodiments of said plate different media flows may be realised and tested.

Preferably a force can be applied to the insulating device in the direction of a fuel cell stack which can be accommodated by the insulating device by a clamping device. Such an external clamping of the fuel cell stack is preferably also used in the actual operation of the fuel cell stack so that in this way the actual operating conditions are reliably reproduced during the test.

It is particularly advantageous that the media supply device comprises an adapter plate via which a fuel cell stack accommodated in the insulating device can be supplied with gaseous fuel or oxidising agent, the adapter plate enabling a guidance of the media through the fuel cell stack in a unidirectional flow or in a counter flow. Such an adapter plate has a plurality of orifices or ports via which a medium can be lead into and out of the fuel cell stack. Said ports may now at least partly be oriented so that they are either covered by the fuel cell stack or are aligned with corresponding ports of the fuel cell stack depending on the positioning of the fuel cell stack on the adapter plate. The positioning of the fuel cell stack can, in this way, determine in which direction the media flows will flow.

Preferably the insulating device comprises micro-porous insulating plates which are at least partly provided with a metallic shell.

It is further particularly advantageous that the media supply device comprises a tempering device for the gaseous fuels to be supplied and/or the oxidising agent to be supplied so that the temperature of the gaseous fuel and/or of the oxidising agent is adjustable and/or controllable. Since beyond this no external heat sources in the form of an oven are required to carry out a test method the thermal balance can be decisively determined by the temperature of the supplied gaseous fuel and particularly the supplied air. By controlling, for example, the temperature of the supplied air the thermal balance of the fuel cell stack can be reliably influenced.

In addition it may be contemplated that at least one heat source and/or heat sink is provided. Heat sources and/or heat sinks within the test arrangement may symbolise further system components of a fuel cell system. In many fuel cell systems, for example, an afterburner is provided to which, in particular, anode waste gas is supplied. In a realistic case it thus represents a heat source which may be simulated by the heat source provided in the test stand. For example, in the mobile sector the hydrogen supplied to the fuel cell stack is preferably generated in a reformer. A reformer may be a heat source as well as a heat sink or may behave thermally neutral depending on whether it is operated exothermally, endothermally or autothermally.

The invention further comprises a test method for a fuel cell stack comprising the steps of: thermally insulating the fuel cell stack, supplying a gaseous fuel and an oxidising agent to the fuel cell stack, and adjusting the temperature of the fuel cell stack by specifically influencing the temperature of the supplied gaseous fuel and/or of the supplied oxidising agent. In this manner the advantages and particularities of the test stand according to the invention are also realised within the framework of a test method. This also applies to the particularly preferred embodiments of the test method according to the invention mentioned below.

It is preferably formed so that the temperature of the fuel cell stack is adjusted by controlling the temperature of the supplied gaseous fuel and/or of the supplied oxidising agent.

Further it is conveniently contemplated that an electric load is simulated and that the operational behaviour of the fuel cell stack is detected depending on the load.

It is further advantageous that an adapter plate is used for guiding media through the fuel cell stack in a unidirectional flow or in a counter flow.

It may further be conveniently contemplated that the temperature of the fuel cell stack is influenced by supplying or removing heat with the aid of a heat source or a heat sink.

The invention is based on the finding that insulation elements closely surrounding the SOFC fuel cell stack provide a good thermal insulation of the fuel cell stack. An insulating device realised by individual insulating plates can be easily and repeatedly mounted and dismounted. By disposing the media heater in or on the insulation elements temperature losses can be avoided due to the short paths outside of the insulating device. An independent control with respect to the media volume flows, the media temperature and the output of the fuel cell stack may be effected.

The invention will now be described by way of example with the aid of particularly preferred embodiments with reference to the accompanying drawings in which:

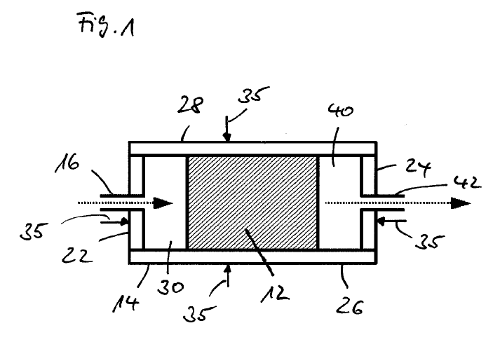

FIG. 1 is a schematic cross sectional view of an insulating device including the fuel cell stack disposed therein;

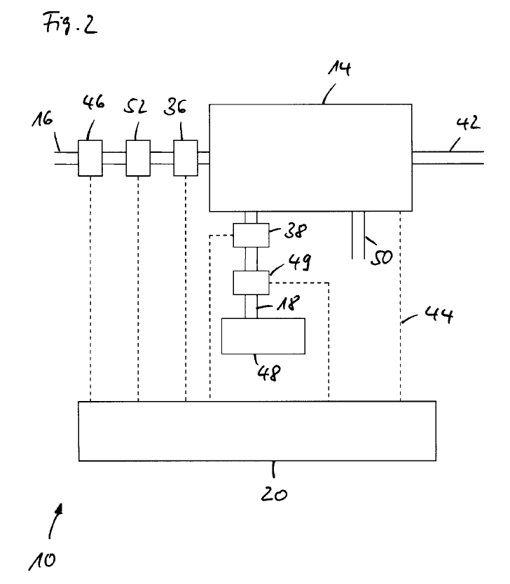

FIG. 2 is a schematic representation of a test stand;

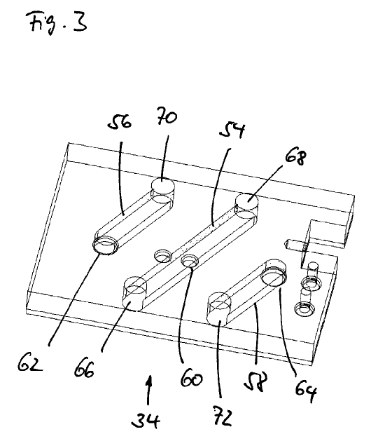

FIG. 3 is a perspective representation of an adapter plate;

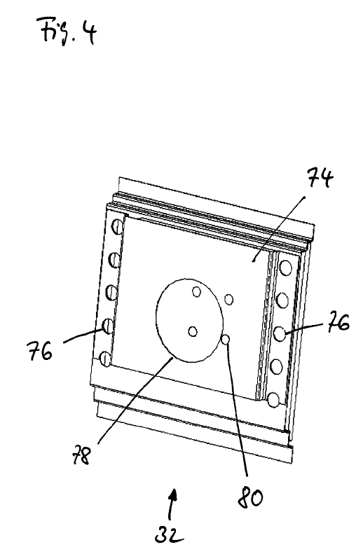

FIG. 4 is a schematic representation of a baffle and distributor plate; and

FIG. 5 is a cross sectional view of an oven including a fuel cell stack disposed therein.

In the following description of the drawings the same numerals designate identical or comparable components.

FIG. 1 shows a schematic cross sectional view of an insulating device including a fuel cell stack disposed therein. The insulating device 14 comprises a plurality of insulating plates 22, 24, 26, 28. The fuel cell stack 12 is tightly packed by the lower insulating plate 26 and the upper insulating plate 28 while the other insulating plates 22, 24 shown are spaced apart from the fuel cell stack 12. Two further insulating plates disposed below or above the drawing plane of the present cross sectional view are also arranged without a distance to the fuel cell stack 12. A force 35 is applied to the insulating device 14 from all sides by a clamping device. In one of the insulating plates 22 spaced apart from the fuel cell stack 12 an air supply 16 is integrated while the air discharge 42 is accommodated in the opposite plate 24. The volumes 30, 40 disposed between the insulating plates 22, 24 and the fuel cell stack 12 thus serve to distribute the air to be supplied to the fuel cell stack 12 or to bundle the air leaving the fuel cell stack. To influence the entry of air into the fuel cell stack 12 a baffle and distributor plate which will be explained in more detail with reference to FIG. 4 may be disposed in the volume 30 between the insulating plate 22 and the fuel cell stack 12.

FIG. 2 shows a schematic representation of a test stand. In addition to the insulating device 14 a control device 20 is provided as a further important component. It is connected to various components of the media supply device 16, 18 so that said components can be controlled or regulated. Furthermore the control device 20 may be an electric load for a fuel cell stack to be arranged in the insulating device 14. For this purpose an electric connection 44 is provided between the control device 20 and the insulating device 14 accommodating the fuel cell stack or in the interior of the insulating device 14. The air supply 16 comprises a device 46 for the volume flow control and a tempering device 36. In this way the air flow can be influenced via the volume flow while the air temperature is adjusted by the tempering device 36. The gaseous fuel supply 18 is connected with a gaseous fuel reservoir 48. It also comprises a tempering device 38 as well as a device for influencing the gaseous fuel flow, for example a proportional valve 49. The air supplied to the insulating device 14 flows out of the insulating device via the air discharge 42 as cathode exhaust air after having passed and partly reacted in the fuel cell stack. The anode waste gas flows out of the gaseous fuel discharge 50 in a comparable manner. Representative of other components which may be provided in the air supply 16 as well as in the gaseous fuel supply 18 an additional component 52 is shown in the air supply 16. It may be another device for influencing the media flow or a measuring device, for example for determining a flow rate, a temperature, a pressure or another amount which may influence the operational behaviour of the fuel cell stack.

FIG. 3 shows a perspective representation of an adapter plate. The adapter plate 34 which is, in the present example, disposed below the fuel cell stack as a part of the insulating device 14 comprises three passages 54, 56, 58. The central passage 54 is connected to an orifice 60 via which gaseous fuel can be supplied. The passages 56, 58 are respectively connected to an orifice 62, 64 via which the anode waste gas can be discharged after having passed the fuel cell stack. The central passage 54 further comprises two ports 66, 68 while the outer passages 56, 58 each comprise a port 70, 72. Such an arrangement in an adapter plate 34 is suitable for a fuel cell stack having a fuel inlet and a fuel outlet. Namely, if the fuel cell stack is placed on the adapter plate 34 two of the ports are closed by the fuel cell stack while the other two ports are connected to the gaseous fuel or waste gas passage of the fuel cell stack. If the fuel cell stack is, for example, placed on the adapter plate 34 so that the ports 66, 72 are closed while the ports 68, 70 are connected to the gaseous fuel passage or the waste gas passage of the fuel cell stack gaseous fuel flows from the gaseous fuel port 60 of the adapter plate to the port 68, from there into the anode spaces of the fuel cell stack, from there to the port 70, and from there to the outside via the gaseous fuel outlet 62. If the fuel cell stack is rotated by 180° the ports 68, 70 are blind while the ports 66, 72 have the described functionality. The essential advantage of the adapter plate 34 is that the gaseous fuel or waste gas ports on the insulating device do not need to be changed. The guidance of the gaseous fuel through the fuel cell stack, namely in the unidirectional flow or in the counter flow mode, may be varied by simply rotating the fuel cell stack. If a fuel cell stack is provided with more than one gaseous fuel supply and one gaseous fuel discharge the number of the ports and passages may be increased correspondingly so that a simple interface of the insulating device may be provided in any case with respect to the gaseous fuel supply.

FIG. 4 shows a schematic representation of a baffle and distribution plate. The plate 32 may be disposed in the free volume 30 provided between the insulating plate 22 on the air inlet side and the fuel cell stack 12 (see FIG. 1). The plate 32 comprises a central section 74 serving as a free section. The air centrally flowing into the insulating device 14 is therefore not supplied to the fuel cell stack 12 directly but distributed in the partial volume upstream of the plate 32. Therefore the air also reaches the peripheral area of the plate 32 where it may enter the other partial volume upstream of the fuel cell stack 12 via a plurality of through holes 76 to then flow to the cathode spaces of the fuel cell stack in a distributed manner. In its central section 74 the plate 32 may be provided with a closable through hole 78 as well as fixing means 80. With the aid of the configuration of the baffle and distributor plate different air flows to and through the fuel cell stack may be realised. To test different air flows with one and the same testing arrangement only one distributor plate has to be replaced by another one having a different design.

The features disclosed in the above description, in the drawings as well as in the claims may be important for the realisation of the invention individually as well as in any combination.

### LIST OF NUMERALS

10 test stand
12 fuel cell stack
14 insulating device
16 media supply device
18 media supply device
20 control device
22 insulating plate
24 insulating plate
26 insulating plate
28 insulating plate
30 volume
32 adapter plate, insulating plate
34 adapter plate
35 force
36 tempering device
38 tempering device
40 volume
44 connection
46 device for controlling the volume flow
48 fuel reservoir
49 proportional valve
50 gaseous fuel discharge
52 additional component
54 central passage
56 outer passage
58 outer passage
60 orifice, gaseous fuel port
62 orifice, gaseous fuel outlet
64 orifice
66 port
68 port
70 port
72 port
74 central section
76 through hole
78 through hole
80 fixing means
110 oven
112 base plate
114 walls
116 fuel cell stack
118 heating elements
120 air supply path
122 air discharge path
124 heat radiation

1. A test stand for a fuel cell stack comprising:
an insulating device for thermally insulating the fuel cell stack,
a media supply device for supplying a gaseous fuel and an oxidising agent to the fuel cell stack, and
an electronic control device for controlling and/or regulating as well as monitoring a test method.

2. The test stand of claim 1, further comprising a device for simulating an electric load which absorbs electric energy generated by the fuel cell stack.

3. The test stand of claim 1, wherein the insulating device comprises a plurality of insulating plates, the media supply device being at least partially integrated in at least one insulating plate.

4. The test stand of claim 3, wherein the insulating device comprises six insulating plates capable of accommodating the fuel cell stack in a cuboid shape, four insulating plates abutting to the fuel cell stack and two insulating plates being spaced apart from the fuel cell stack.

5. The test stand of claim 4, further comprising a plate which brings about a distribution of a medium to be supplied to the fuel cell stack between of one insulating plate disposed in a distance from the fuel cell stack and the volume provided for the fuel cell stack.

6. The test stand of claim 1, wherein a force can be applied to the insulating device in the direction of a fuel cell stack which can be accommodated by the insulating device by a clamping device.

7. The test stand of claim 1, wherein the media supply device comprises an adapter plate via which gaseous fuel or oxidising agent is supplyable to a fuel cell stack accommodated by the insulating device, the adapter plate enabling a guidance of the media through the fuel cell stack in a unidirectional flow or in a counter flow.

8. The test stand of claim 1, wherein the insulating device comprises micro-porous insulating plates provided, at least partly, with a metallic shell.

9. The test stand of claim 1, wherein the media supply device is provided with a tempering device for the gaseous fuels to be supplied and/or the oxidising agent to be supplied so that the temperature of the gaseous fuel and/or of the oxidising agent is adjustable and/or controllable.

10. The test stand of claim 1, wherein at least one heat source and/or heat sink is provided.

11. A test method for a fuel cell stack comprising the steps:
thermally insulating the fuel cell stack,
supplying gaseous fuel and oxidising agent to the fuel cell stack, and
adjusting the temperature of the fuel cell stack by specifically influencing the temperature of the supplied gaseous fuel and/or of the supplied oxidising agent.

12. The method of claim 11, wherein the step of adjusting the temperature of the fuel cell stack is by controlling the temperature of the supplied gaseous fuel and/or of the supplied oxidising agent.

13. The method of claim 11, further comprising the steps of simulating an electric load and detecting the operational behaviour of the fuel cell stack is detected depending on the load.

14. The method of claim 11, wherein an adapter plate is used for guiding media through the fuel cell stack in a unidirectional flow or in a counter flow.

15. The method of claim 11, wherein the temperature of the fuel cell stack is influenced by supplying or removing heat by means of a heat source or a heat sink.

16. An adapter plate for providing ports for a fuel cell stack, having at least three passages, a central passage having a fuel supply opening facing away from the fuel cell stack to be placed on the adapter plate and two fuel cell connecting openings facing in the direction of the fuel cell stack to be placed on the adapter plate, and wherein two outer passages each having a waste gas opening facing away from the fuel cell stack to be placed on the adapter plate and each having a waste gas discharge fuel cell stack connecting opening facing in the direction of the fuel cell stack to be placed on the adapter plate, wherein the fuel cell stack connecting openings are arranged such that in a first position relative to the adapter plate the fuel cell stack closes a first fuel supply fuel cell stack connecting opening and is connected to a second fuel supply fuel cell stack connecting opening and closes a first waste gas discharge fuel cell stack connecting opening and is connected to a second waste gas discharge fuel cell stack connecting opening, and in a second position relative to the adapter plate closes the second fuel supply fuel cell stack connecting opening and is connected to the first fuel supply fuel cell stack connecting opening and closes the second waste gas discharge fuel cell stack connecting opening and is connected to the first waste gas discharge fuel cell stack connecting opening, wherein a transfer between the first position and the second position is achieved by a relative rotation of the fuel cell stack and the adapter plate by 180°.

17. Adapter plate of claim 16, wherein the adapter plate is part of an insulating device to be arranged underneath a fuel cell stack.
